(19) United States
(12) Patent Application Publication
(10) Pub. No.: US 2019/0268352 A1
(43) Pub. Date: Aug. 29, 2019

(54) METHOD FOR CONTENT DISARM AND RECONSTRUCTION (CDR)

(71) Applicant: OPSWAT, Inc., San Francisco, CA (US)

(72) Inventors: Taeil Goh, San Francisco, CA (US); Vinh Nguyen Xuan Lam, San Francisco, CA (US); Nhut Minh Ngo, Ho Chi Minih City (VN); Dung Huu Nguyen, Ho Chi Minih City (VN)

(73) Assignee: OPSWAT, Inc., San Francisco, CA (US)

(21) Appl. No.: 15/905,441

(22) Filed: Feb. 26, 2018

(51) Int. Cl. H04L 29/06; G06F 21/56

(52) U.S. Cl. CPC H04L 63/145; G06F 2221/034; G06F 21/568; G06F 21/565

(57) ABSTRACT

A Content Disarm and Reconstruction (CDR) method is disclosed including a computer receiving an input file having a file format configured with a structured storage. The computer disassembles the structured storage into at least one subfile. Each subfile is a stream subfile. For each subfile, the computer identifies an item in the stream subfile. The computer analyzes the item in the stream subfile for an unwanted behavior by determining an acceptability of the unwanted behavior, distinguishing a visibility of the item, and recognizing a necessity of the item. The computer, based on a result of the analyzing step, processes the item in the stream subfile resulting in a processed subfile. The computer assembles the processed subfiles into an output file having the same file format as the file format as the input file.

### BACKGROUND

One method of compromising computer security involves sharing common document types or image files that when opened, execute embedded malicious code. Popular techniques used to accomplish this may include VBA macros, exploit payloads, and embedded Flash or JavaScript code. Common document types or image files for document-borne malware may include files such as word processing documents (i.e., DOC, DOCX, RTF or XLS), images files (i.e., PNG, JPEG), and portable document files (i.e., PDF or PPT).

Content Disarm and Reconstruction (CDR) is a computer security technology widely used in cyber security industries to prevent cyber security threats from entering a network. Generally, CDR removes malicious threats from files by removing file components. In some CDR methods, file-type conversions are performed. For example, a file in format A is converted to a file in format B (A-B), or a file in format A is converted to a file in format B then the file in format B is converted back to a file in format A (A-B-A). In other CDR methods, incoming files are processed according to the system's rules, standards and policies by deconstructing the file, and removing the elements that do not match the file type's standards or set policies. The files are then rebuilt into clean versions for an end user.

CDR technology is frequently used for common document types in the United States, such as Microsoft® Office documents, but rarely supports file formats outside of the US which may also be targeted in attacks. JTD (Ichitaro Word Processing) and HWP (Hangul Word Processor) and are widely used file formats in Japan and South Korea respectively.

### SUMMARY

A Content Disarm and Reconstruction (CDR) method is disclosed including a computer receiving an input file having a file format configured with a structured storage. The computer disassembles the structured storage into at least one subfile. Each subfile is a stream subfile. For each subfile, the computer identifies an item in the stream subfile. The computer analyzes the item in the stream subfile for an unwanted behavior by determining an acceptability of the unwanted behavior, distinguishing a visibility of the item, and recognizing a necessity of the item. The computer, based on a result of the analyzing step, processes the item in the stream subfile resulting in a processed subfile. The computer assembles the processed subfiles into an output file having the same file format as the file format as the input file.

A computerized system is disclosed including a memory storing executable instructions and a processor. The processor is coupled to the memory and performs a Content Disarm and Reconstruction (CDR) method by executing the instructions stored in the memory. The method includes the processor receiving an input file having a file format configured with a structured storage. The processor disassembles the structured storage into at least one subfile. Each subfile is a stream subfile. For each subfile, the processor identifies an item in the stream subfile. The processor analyzes the item in the stream subfile for an unwanted behavior by determining an acceptability of the unwanted behavior, distinguishing a visibility of the item, and recognizing a necessity of the item. The processor, based on a result of the analyzing step, processes the item in the stream subfile resulting in a processed subfile. The processor assembles the processed subfiles into an output file having the same file format as the file format as the input file.

A non-transitory computer readable medium includes instructions that, when executed by a processor, cause the processor to perform operations including the processor receiving an input file having a file format configured with a structured storage. The processor disassembles the structured storage into at least one subfile. Each subfile is a stream subfile. For each subfile, the processor processes an item in the stream subfile. The processor analyzes the item in the stream subfile for an unwanted behavior by determining an acceptability of the unwanted behavior, distinguishing a visibility of the item, and recognizing a necessity of the item. The processor, based on a result of the analyzing step, processes the item in the stream subfile resulting in a processed subfile. The processor assembles the processed subfiles into an output file having the same file format as the file format as the input file.

The method, system or medium further comprising editing the output file with the file format word processing software of the input file.

In some embodiments, the file format is configured as a JTD (Ichitaro Word Processing) document file type having structure based on a Microsoft Compound Document File (MCDF) format for the structured storage. In other embodiments, the file format is configured as a HWP (Hangul Word Processor) document file type having structure based on a Microsoft Compound Document File (MCDF) format for the structured storage.

The output file is based on a Microsoft Compound Document File (MCDF) format for the structured storage. The output file has less unwanted behavior or no unwanted behavior when compared to the input file.

In various embodiments, the processing the item is performed by modifying the item in the stream subfile resulting in the processed subfile. The processing the item is performed by removing the item from the stream subfile resulting in the processed subfile. The processing the item is performed by keeping the item from the stream subfile resulting in the processed subfile.

### DESCRIPTION OF DRAWINGS

FIG. 1 is a simplified schematic of an example communication system, in accordance with some embodiments.

FIG. 2 is a simplified flowchart for a CDR method, in accordance with some embodiments.

FIG. 3 depicts a simplified schematic of the compound document file with a hierarchy of subfiles, in accordance with some embodiments.

FIG. 4 is a simplified flowchart for a portion of the CDR method, in accordance with some embodiments.

FIG. 5 is a table for a JTD document file type illustrating example embodiments for the CDR method, in accordance with some embodiments.

FIG. 6 is a table for a HWP document file type illustrating example embodiments for the CDR method, in accordance with some embodiments.

FIG. 7 shows a simplified flowchart for a portion of the CDR method, in accordance with some embodiments.

FIG. 8 is a simplified schematic diagram showing an example server for use in the communication system, in accordance with some embodiments.

### DETAILED DESCRIPTION

Cybersecurity solutions generally refer to protecting against a variety of forms of harmful or intrusive software, including computer viruses, worms, Trojan horses, ransomware, spyware, adware, scareware, and other malicious programs which can take the form of executable code, scripts, active content, and other software. Cybersecurity solutions such as antivirus software, anti-malware software and firewalls are used to protect against malicious activity. For example, malware embedded in items of documents is designed to be completely invisible to the user so that when a file is opened, the user may be completely unaware of a script running in the background, leveraging the malware to infect their device and possibly network. Content disarm and reconstruction (CDR), or data sanitization, includes technologies designed to remove the embedded objects, exploits and zero-day attacks from files while preserving the usability of a file. Also known as “threat extraction” or “cleanse safe for use,” data sanitization is usually accomplished by altering the internal structure of a file, removing content or converting a file to a different format. The CDR method disclosed herein meticulously deconstructs the file then reconstructs the file while maintaining the original file structure and format. This ensures the usability of the file is not impacted and protects the formatting of the file thereby allowing the original style of the file to be maintained while disarming potential threats.

The CDR method may be used on common document types, image files or electronic communications such as emails. JTD (Ichitaro Word Processing) files and HWP (Hangul Word Processor) files are less common in the United States, but widely used file formats in Japan and South Korea respectively. JTD is a Japanese word processing software with a document file type having structure based on a Microsoft® Compound Document File (MCDF) format for the structured storage. It uses Japanese characters when creating documents and is commonly used to create letters, reports, proposals and memorandums for Japanese businesses. HWP is a proprietary word processing application which supports the Korean written language (including processing Middle Korean) with a document file type having structure based on a Microsoft® Compound Document File (MCDF) format for the structured storage.

It is commonly known that cybersecurity solutions have not focused on detecting malicious activity in JTD or HWP due to their regional file format and use of dedicated, localized software which has a low presence in outside markets. As such, these file types are easy targets for attacks which are occurring frequently in Japan and South Korea.

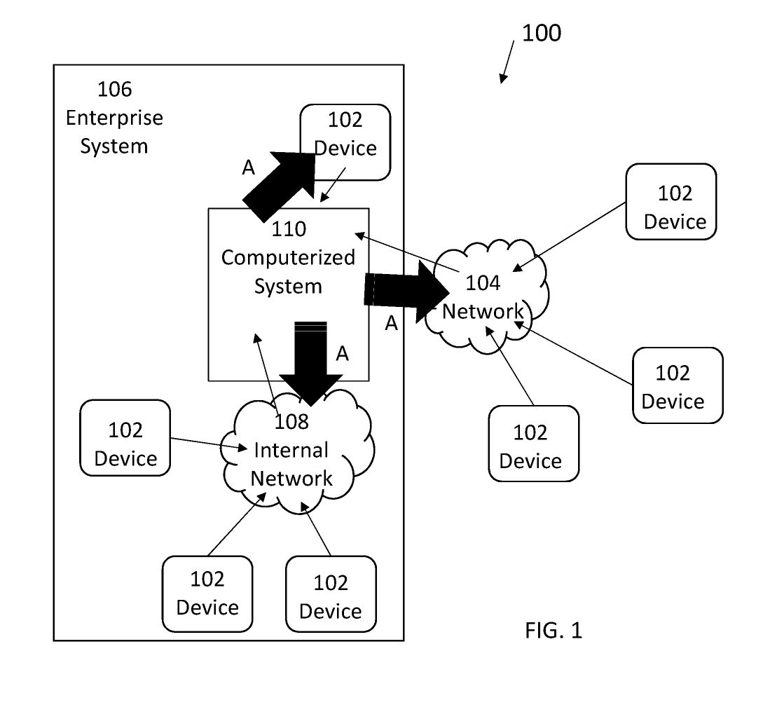

FIG. 1 is a simplified schematic of an example communication system 100, in accordance with some embodiments, with which users communicate with each other using a variety of communication devices 102, such as personal computers, laptop computers, tablets, mobile phones, landline phones, smartwatches, smart cars, or the like, operated by a user. The devices 102 generally transmit and receive communications such as files, data and emails, through a variety of paths, communication access systems or networks 104. The networks 104 may be a variety of carriers for telephone services, third-party communication service systems, third-party application cloud systems, third-party customer cloud systems, cloud-based broker service systems (e.g., to facilitate integration of different communication services), on-premises enterprise systems, or other potential systems. In some embodiments, the communication system 100 includes an on-premises enterprise system 106 which may be a computer, a group of computers, a server, a server farm or a cloud computing system.

The enterprise system 106 may include an internal network 108 through which internal communication devices 102 communicate. A computerized system 110 is included which receives all communication such as data or files transmitted to or within the enterprise system 106. In some embodiments, the computerized system 110 receives the files through the network 104, the internal networks 108 or directly from some of the devices 102. The files may be common document types, image files or emails. In this way, the incoming files can be evaluated using security measures, thus protecting the enterprise system 106 and devices 102 from known or unknown threats. The incoming files can be sanitized by the computerized system 110 and then returned to the network 104, the internal networks 108 or directly to the devices 102 as indicated by arrows A. In some embodiments, the computerized system 110 (or a part thereof) is part of the on-premises enterprise system 106 or a regional communication system and may be associated with one or a plurality of such enterprises 106, entities or business organizations.

In accordance with the description herein, the various illustrated components of the communication system 100 generally represent appropriate hardware and software components for providing the described resources and performing the described functions. The hardware generally includes any appropriate number and combination of computing devices, network communication devices, and peripheral components connected together, including various processors, computer memory (including transitory and non-transitory media), input/output devices, user interface devices, communication adapters, communication channels, etc. The software generally includes any appropriate number and combination of conventional and specially-developed software with computer-readable instructions stored by the computer memory in non-transitory computer-readable or machine-readable media and executed by the various processors to perform the functions described herein.

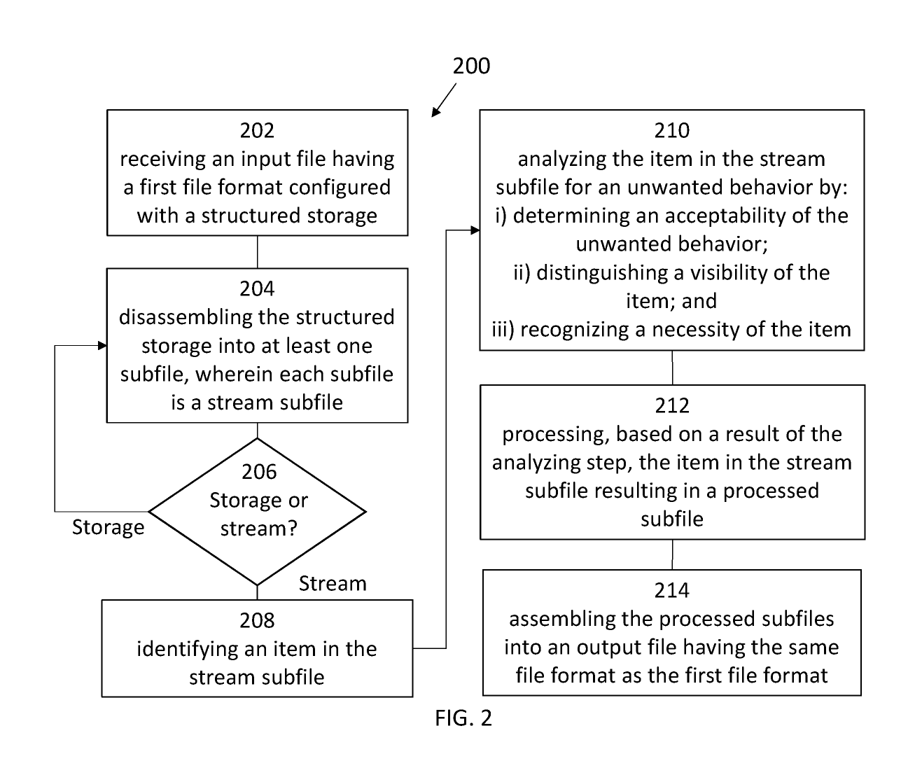

A Content Disarm and Reconstruction (CDR) method is a security measure used by the computerized system 110 of the enterprise system 106 to sanitize files for embedded malicious code before the files enter the enterprise system 106 or the other devices 102. The incoming file may or may not contain executable data and may contain malicious content (including zero-day threats) that can be executed. FIG. 2 is a simplified flowchart for a CDR method 200, in accordance with some embodiments that performs the sanitization by traversing storage subfiles and stream subfiles, modifying the subfiles without disrupting the overall structure integrity, and then assembling the subfiles, while maintaining the original file format specification. The illustrated and described steps, order of steps, and combination of steps are provided for explanatory purposes only. Other embodiments may use other specific steps, order of steps, and combination of steps to achieve similar results.

At step 202, computerized system 110 of the enterprise system 106, receives an input file having a file format configured with, for example, a structured storage. The structured storage file format is a compound document file with a plurality of data which are organized in a hierarchy of subfiles consisting of storages and streams. For example, in some embodiments, the file format may be configured as a JTD document file type having structure based on a MCDF format for the structured storage. In other embodiments, the file format is configured as a HWP document file type having structure based on a MCDF format for the structured storage.

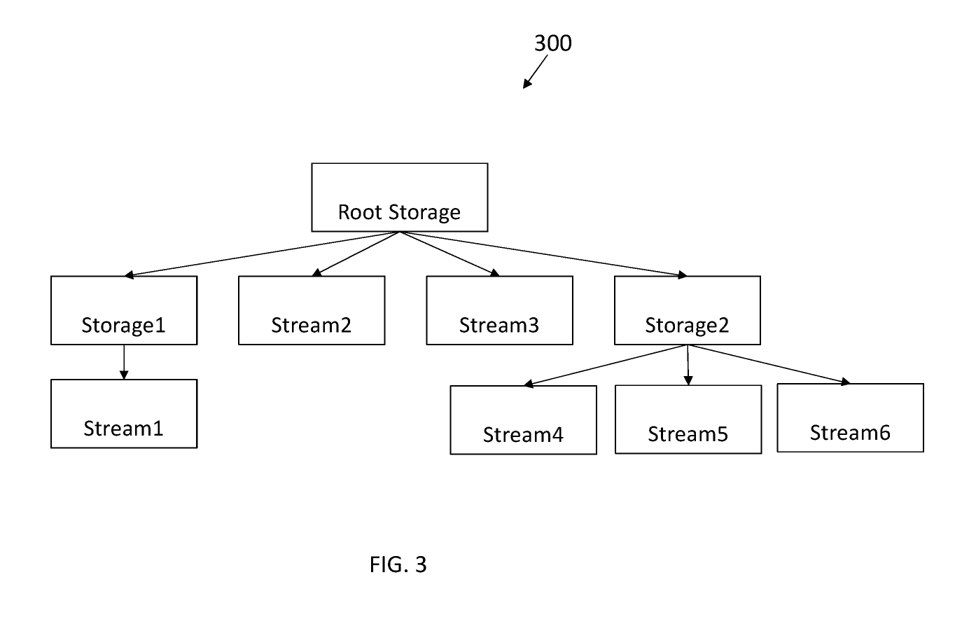

The computerized system 110 assumes that all files are suspected to possibly contain malicious code. At step 204, the computerized system 110 disassembles the structured storage into at least one subfile. This is accomplished by traversing the storage subfiles and stream subfiles. At step 206, if the subfile is a storage subfile, step 204 is repeated until each subfile is a stream subfile. FIG. 3 depicts a simplified schematic of the compound document file with the hierarchy of subfiles 300, in accordance with some embodiments. In this example, the root storage is the file and it is disassembled into subfiles until all the subfiles are stream subfiles.

Referring to FIG. 2, at step 208, for each subfile, the computerized system 110 identifies an item in the stream subfile. At step 210, the computerized system 110 analyzes the item in the stream subfile for an unwanted behavior by determining an acceptability of the unwanted behavior, distinguishing a visibility of the item, and recognizing a necessity of the item. These may be determined and set according to rules, standards and policies which may be established by program, software, administrator or human input. The acceptability of the unwanted behavior is associated with the amount of risk of causing harm to the network, communication system or device. The visibility of the item is associated with the function or behavior of the item, such that the item is present in the file but may or may not be ‘readable’ to, or ‘viewable’ by, the user. For example, an image in the file is present and visible to the user. In other words, the user can ‘see’ the image. A macro, on the other hand, is present but not visible to the user because it is programmable instructions. Font is considered to be partially visible because the user can see the font but not the control characters to set the font. The necessity of the item is associated with the structure of the file. For example, an assessment of the item may be performed to determine if the item causes the structure of the file to break, thereby corrupting the file. If the item causes the structure of the file to break, then the item is recognized as a necessity and mandatory. A header in the file may be mandatory whereas a hyperlink is not mandatory.

At step 212, the computerized system 110, based on a result of the analyzing step, processes the item in the stream subfile resulting in a processed subfile. Steps 210 and 212 are repeated for each stream subfile, generally resulting in multiple processed subfiles. At step 214, the computerized system 110 assembles the processed subfiles into an output file having the same file format as the file format of the input file.

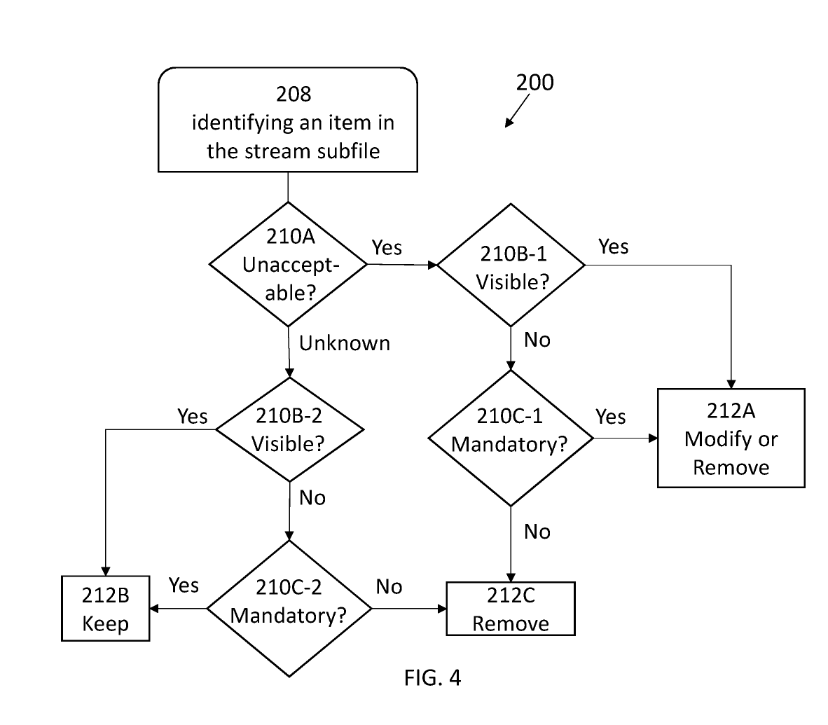

As described at step 208, the computerized system 110 identifies an item in the stream subfile. FIG. 4 is a simplified flowchart for a portion of the CDR method 200, in accordance with some embodiments, detailing steps 210 and 212 of the CDR method 200. At step 210A, the computerized system 110 analyzes the stream subfile with items for an unwanted behavior by determining an acceptability of the unwanted behavior. For example, the item is analyzed to determine if the acceptability of the unwanted behavior is unacceptable (e.g., yes), acceptable (e.g., no) or unknown. Although, both “no” and “unknown” can be treated the same in some embodiments, since both may be considered a low risk. Depending on the outcome of step 210, at steps 210B-1 and 210B-2, the visibility of the item is distinguished which may be visible (e.g., fully or partially) or hidden. At steps 210C-1 or 210C-2, the necessity of the item is recognized as mandatory or not mandatory to the file. Based on these results, at steps 212A, 212B or 212C, the item in the stream subfile is processed by keeping the item in the stream subfile (step 212B) resulting in the processed subfile, removing the item in the stream subfile (step 212A or 212C) resulting in the processed subfile, or modifying the item in the stream subfile (step 212A) resulting in the processed subfile.

In some embodiments, the item in the stream subfile may be kept to maximize the productivity and file conformity, such as when the stream subfile has an unknown unacceptability level of unwanted behavior, contains visible content, or when the stream subfile has an unknown unacceptability level of unwanted behavior, contains no visible content and is mandatory to the structure of the file. In some embodiments, the item in the stream subfile may be removed to minimize the security risk without affecting the file conformity, such as when the stream subfile has an unacceptable level of unwanted behavior, contains no visible contents, and is not mandatory to the structure of the file, or when the stream subfile has an unknown unacceptability level of unwanted behavior, contains no visible contents, and is not mandatory to the structure of the file. In some embodiments, the item in the stream subfile may be modified to maximize the productivity and file conformity, and minimize the security risk, such as when the stream subfile has an unacceptable level of unwanted behavior and either contains visible contents or is mandatory to the structure of the file.

Referring to FIG. 2, at step 214, the computerized system 110 assembles the processed subfiles into an output file having the same file format as the file format as the input file. For example, if the input file has the file format configured as a JTD document file type having structure based on the MCDF format for the structured storage, then the output file has the file format configured as a JTD document file type having structure based on the MCDF format for the structured storage. Likewise, if the input file has the file format configured as a HWP document file type having structure based on the MCDF format for the structured storage, then the output file has the file format configured as a HWP document file type having structure based on the MCDF format for the structured storage.

After performing the CDR method 200, and the processed subfiles are assembled into the output file, the output file has less unwanted behavior or no unwanted behavior when compared to the input file. This means that the threat, risk or malicious code is negated and the file is sanitized. The output file is based on the MCDF format for the structured storage thereby maintaining the structure and integrity of the hierarchy of subfiles. Also, because the file is disassembled then reassembled maintaining the same file format, for example,—HWP—as the original file, the file can be edited with the file format word processing software of the input file, such as with Hangul word processing software. This may not be true in other CDR methods available in the marketplace.

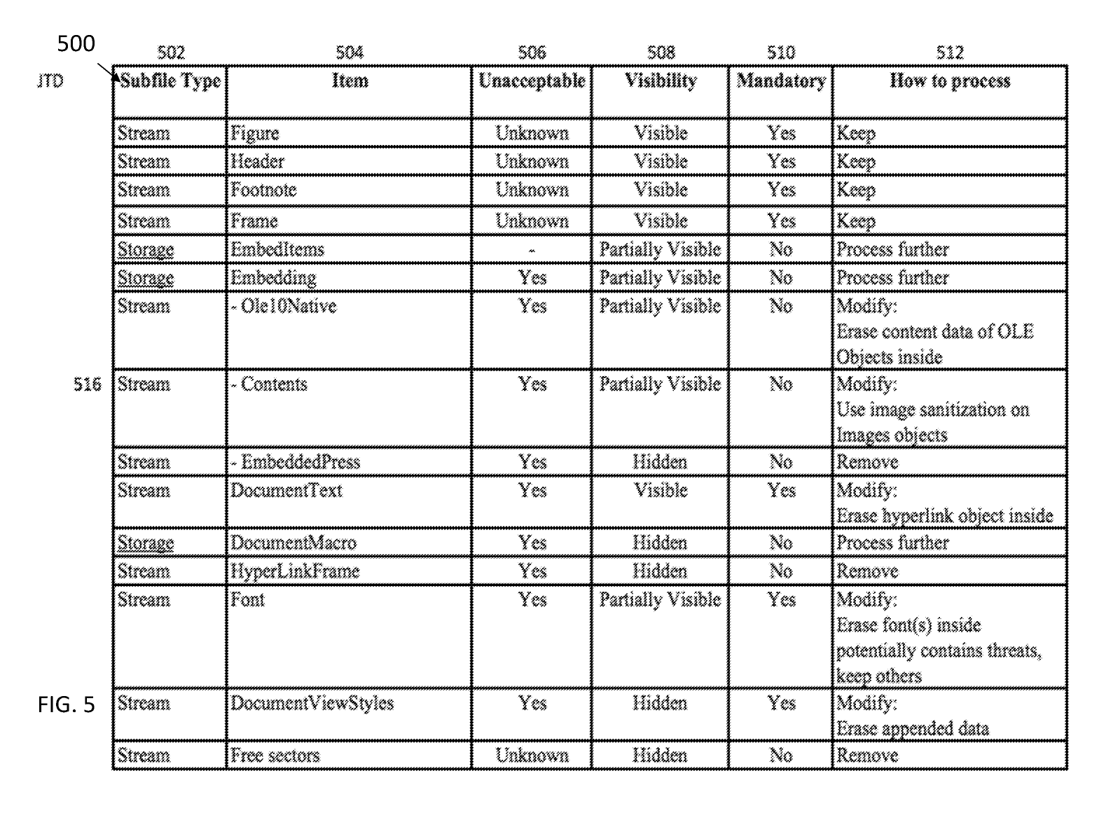

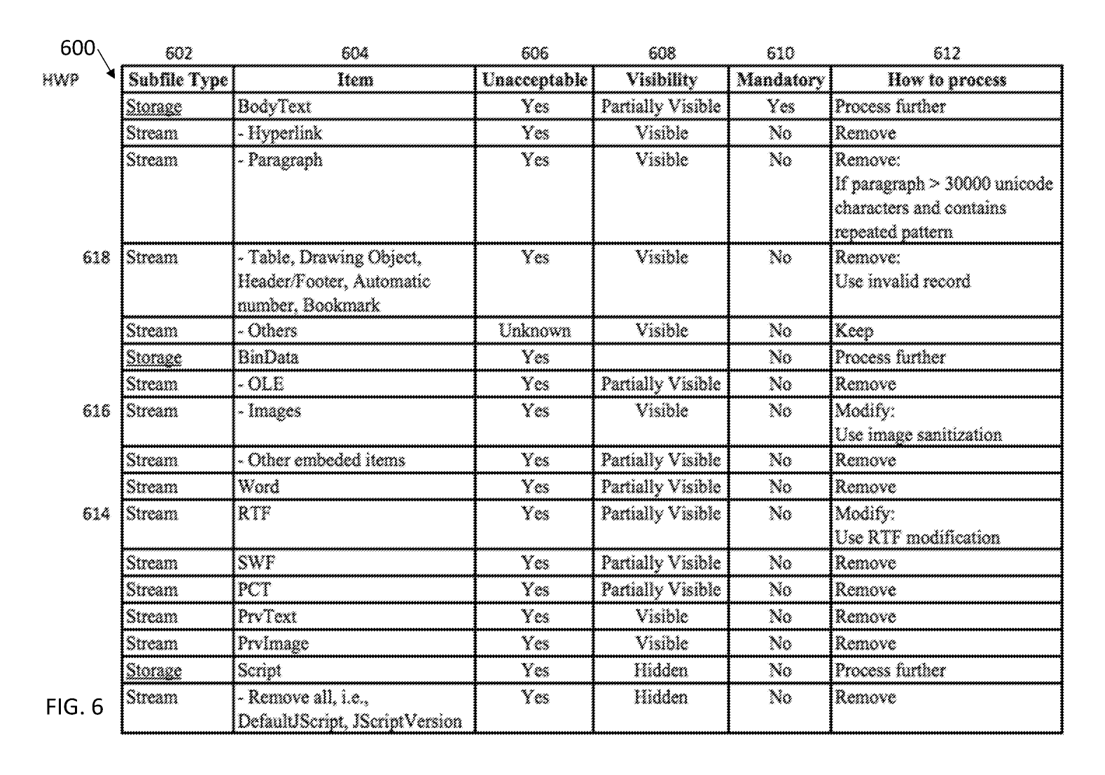

FIG. 5 is a table for a JTD document file type 500 illustrating example embodiments for the CDR method 200, in accordance with some embodiments. FIG. 6 is a table for a HWP document file type 600 illustrating example embodiments for the CDR method 200, in accordance with some embodiments. Columns 502 and 602 respectively, identify the subfile type, for example, storage or stream.

An item, listed in columns 504/604, may be part of a document such as a figure, header, footer, footnote, document text, hyperlink, font, document view style, paragraph, table, object, bookmark, OLE, image, embedded content, RTF (rich text format), SWF (small web format), PCT (picture image file), or the like. Tables 500 and 600 detail the embodiments for analyzing the item in the stream subfile for an unwanted behavior by determining an acceptability of the unwanted behavior as listed in columns 506/606. Columns 508/608 list the visibility of the item, and columns 510/610 list the necessity of the item. Columns 512/612 detail how to process the item.

When the subfile type is identified as storage, columns 512/612 identify how to process as Process further. This corresponds to steps 204 and 206 of FIG. 2 to continue disassembling the structured storage into at least one subfile until each subfile is a stream subfile.

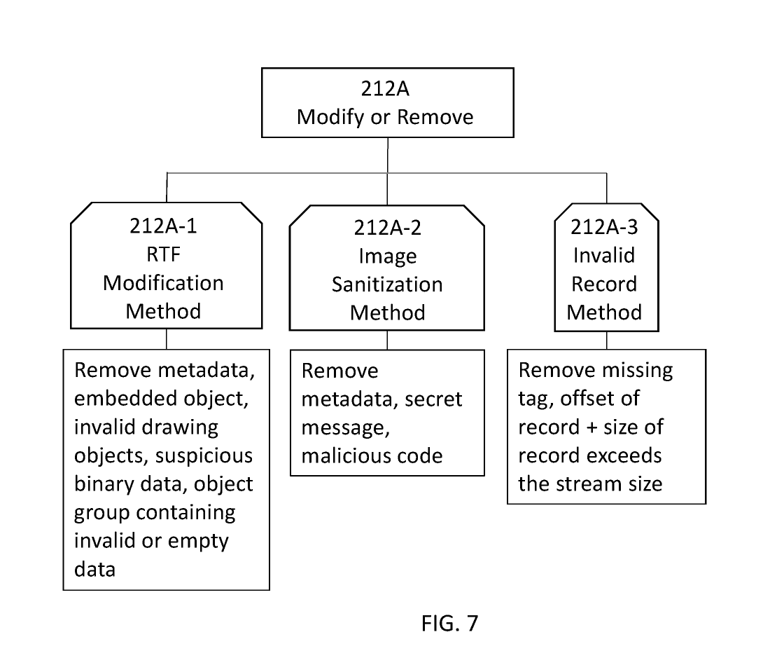

FIG. 7 shows a simplified flowchart for a portion of the CDR method 200, in accordance with some embodiments, detailing specific techniques to modify or remove items. Referring to step 212 of FIG. 2, a plurality of methods may be used to modify or remove items. For example, if the item is RTF (see FIG. 6, line 614), a RTF modification method 212A-1 may be used to sanitize the items, objects and file. This may include removing metadata, removing embedded objects, removing invalid drawing objects, removing suspicious binary data (e.g., suspicious text), and removing an object group containing invalid or empty data. A valid object group, for example, may be \dpgroup \dpcount<dphead><dpinfo>+\dpendgroup; whereas, an invalid group, for example, may be dpgroup: dpgroup without dpendgroup or vice versa; empty dpgroup:/dpgroup/dpgroup/dpendgroup/dpendgroup.

In another example, an image sanitization method 212A-2 may be used when the item is an image or image objects (see FIG. 5, line 516 and FIG. 6, line 616). This sanitizes the image and may perform a format conversion from a first file format to the same file format (e.g., JPG to JPG). This may include removing metadata which may not be enabled by default, removing secret messages and removing malicious code.

In another example, an invalid record method 212A-3 may be used when the item is a table, drawing object, header/footer, automatic number, or bookmark (see FIG. 6, line 618). This may include removing missing tags or removing when the offset of record combined with the size of record exceeds the stream size.

The CDR method 200 is performed on the incoming file. In some embodiments, the original files may be archived in a quarantine space in a computer memory or mass storage device, so that they can remain available, in case they are needed for further analysis. Each subfile is analyzed in at least three areas such as determining the acceptability of the unwanted behavior, distinguishing the visibility of the item, and recognizing the necessity of the item. This is a sophisticated approach enabling items to be processed efficiently by keeping, modifying or removing the item based on logic instead of haphazardly modifying every item unnecessarily. It enables the integrity of the structure of the original file format to be maintained so that after processing the output file has the same file format as the original file format and thereby can be edited with the original file format software. There is no conversion from one file format to a different file format then possibly, converting again to the original file format.

Moreover, there is a unique challenge to maintain the functionality of the original file format when using JTD and HWP file formats. Japanese writing systems are based on a combination of two character types, logographic kanji, which are adopted Chinese characters, and syllabic kana. Kana itself consists of a pair of syllabaries (hiragana, and katakana). Almost all written Japanese sentences contain a mixture of kanji and kana therefore having a mixture of scripts and a large inventory of kanji characters. The Korean alphabet consists of consonants and vowels but instead of being written sequentially, letters are grouped into syllabic blocks.

The embodiments described herein are directed to a specific improvement to the technical field or technology of cybersecurity solutions. The present application discloses a Content Disarm and Reconstruction (CDR) method which is effective on common file formats as well as JTD and HWP file formats. In this manner, the present invention is particularly useful for ridding the file of malicious activity while maintaining the functionality of the original file format. In other words, the sanitized file can be edited with the original file format software.

These embodiments are necessarily rooted in computer technology to address a problem specifically arising in the realm of computer technology, is inextricably tied to computer technology, and is not analogous to a traditional cybersecurity practice for some file format types. The problem is unique to the computer environment wherein hackers target electronic files to corrupt files, devices, networks and/or communication systems. The embodiments of the present disclosure protect files, device, networks and communication systems from threats and help secure digital data flow.

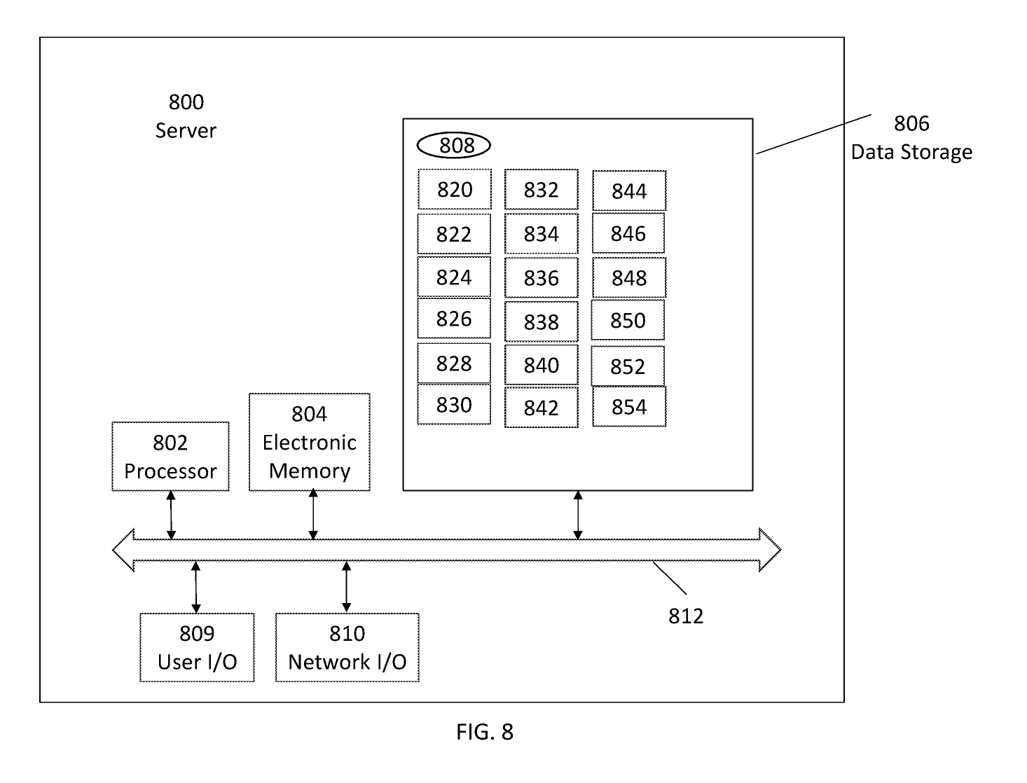

FIG. 8 is a simplified schematic diagram showing an example server 800 (representing any combination of one or more of the servers) for use in the communication system 100, in accordance with some embodiments. Other embodiments may use other components and combinations of components. For example, the server 800 may represent one or more physical computer devices or servers, such as web servers, rack-mounted computers, network storage devices, desktop computers, laptop/notebook computers, etc., depending on the complexity of the communication system 100. In some embodiments implemented at least partially in a cloud network potentially with data synchronized across multiple geolocations, the server 800 may be referred to as one or more cloud servers. In some embodiments, the functions of the server 800 are enabled in a single computer device. In more complex implementations, some of the functions of the computing system are distributed across multiple computer devices, whether within a single server farm facility or multiple physical locations. In some embodiments, the server 800 functions as a single virtual machine.

In some embodiments wherein the server 800 represents multiple computer devices, some of the functions of the server 800 are implemented in some of the computer devices, while other functions are implemented in other computer devices. For example, various portions of the enterprise system 106 can be implemented on the same computer device or separate computer devices. In the illustrated embodiment, the server 800 generally includes at least one processor 802, a main electronic memory 804, a data storage 806, a user I/O 809, and a network I/O 810, among other components not shown for simplicity, connected or coupled together by a data communication subsystem 812.

The processor 802 represents one or more central processing units on one or more PCBs (printed circuit boards) in one or more housings or enclosures. In some embodiments, the processor 802 represents multiple microprocessor units in multiple computer devices at multiple physical locations interconnected by one or more data channels. When executing computer-executable instructions for performing the above described functions of the server 800 in cooperation with the main electronic memory 804, the processor 802 becomes a special purpose computer for performing the functions of the instructions.

The main electronic memory 804 represents one or more RAM modules on one or more PCBs in one or more housings or enclosures. In some embodiments, the main electronic memory 804 represents multiple memory module units in multiple computer devices at multiple physical locations. In operation with the processor 802, the main electronic memory 804 stores the computer-executable instructions executed by, and data processed or generated by, the processor 802 to perform the above described functions of the server 800.

The data storage 806 represents or comprises any appropriate number or combination of internal or external physical mass storage devices, such as hard drives, optical drives, network-attached storage (NAS) devices, flash drives, etc. In some embodiments, the data storage 806 represents multiple mass storage devices in multiple computer devices at multiple physical locations. The data storage 806 generally provides persistent storage (e.g., in a non-transitory computer-readable or machine-readable medium 808) for the programs (e.g., computer-executable instructions) and data used in operation of the processor 802 and the main electronic memory 804.

In some embodiments, the programs and data in the data storage 806 include, but are not limited to, a receiver 820 for receiving an input file; a disassembler 822 for disassembling the structured storage into at least one subfile; an identifier 824 for identifying an item in the stream subfile; an analyzer 826 for analyzing the item in the stream subfile for an unwanted behavior; a determiner 828 for determining an acceptability of the unwanted behavior; a distinguisher 830 for distinguishing a visibility of the item; a recognizer 832 for recognizing a necessity of the item; a sub-processor 834 for processing the item in the stream subfile resulting in a processed subfile; an assembler 836 for assembling the processed subfiles into an output file having the same file format as the file format as the input file; an in-memory message bus 838 for internal communication within the enterprise system 106; an event scheduler 840 for coordinating the scheduling of the CDR method when a file is received; one or more parsing routines 842 for parsing data; a searching routine 844 for searching through the various types of information; a reading routine 846 for reading information from the data storage 806 into the main electronic memory 804; a storing routine 848 for storing original received files and information; a quarantine space 850 for housing the original received files; a network communication services program 852 for sending and receiving network communication packets through the networks 104 and 108; a gateway services program 854 for serving as a gateway to communicate information between servers and users; among other programs and data. Under control of these programs and using this data, the processor 802, in cooperation with the main electronic memory 804, performs the above described functions for the server 800.

The user I/O 809 represents one or more appropriate user interface devices, such as keyboards, pointing devices, displays, etc. In some embodiments, the user I/O 809 represents multiple user interface devices for multiple computer devices at multiple physical locations. A system administrator, for example, may use these devices to access, setup and control the server 800.

The network I/O 810 represents any appropriate networking devices, such as network adapters, etc. for communicating through the communication system 100. In some embodiments, the network I/O 810 represents multiple such networking devices for multiple computer devices at multiple physical locations for communicating through multiple data channels.

The data communication subsystem 812 represents any appropriate communication hardware for connecting the other components in a single unit or in a distributed manner on one or more PCBs, within one or more housings or enclosures, within one or more rack assemblies, within one or more geographical locations, etc.

The computerized system 110 includes a memory 804 storing executable instructions (loaded from the data storage 806) and a processor 802. The processor 802 is coupled to the memory 804 and performs a Content Disarm and Reconstruction (CDR) method 200 by executing the instructions stored in the memory 804. The CDR method 200 includes the processor 802 receiving an input file having a file format configured with a structured storage. The processor 802 disassembles the structured storage into at least one subfile. Each subfile is a stream subfile. The processor 802 identifies an item in the stream subfile. The processor 802 analyzes the item in the stream subfile for an unwanted behavior by determining an acceptability of the unwanted behavior, distinguishing a visibility of the item, and recognizing a necessity of the item. The processor 802, based on a result of the analyzing step, processes the item in the stream subfile resulting in a processed subfile. The processor 802 assembles the processed subfiles into an output file having the same file format as the file format as the input file.

The non-transitory computer readable medium 808 includes instructions (i.e., the programs and data 820-854 described above) that, when executed by the processor 802, cause the processor 802 to perform operations including the CDR method 200 as described herein.

One or more aspects or features of the subject matter described herein can be realized in digital electronic circuitry, integrated circuitry, specially designed application specific integrated circuits (ASICs), field programmable gate arrays (FPGAs), computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or an assembly/machine language. As used herein, the term “machine-readable medium” (i.e., non-transitory computer-readable media) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a machine-readable medium. The machine-readable medium can store such machine instructions non-transitorily, such as for example as would a non-transient solid-state memory or a magnetic hard drive or any similar storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor, for displaying information to the user and a keyboard and a pointing device, such as for example a mouse, a touchpad or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one” or “one or more” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

While the specification has been described in detail with respect to specific embodiments of the present invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the scope of the present invention, which is more particularly set forth in the appended claims.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A Content Disarm and Reconstruction (CDR) method comprising:
receiving, by a computer, an input file having a file format configured with a structured storage;
disassembling, by the computer, the structured storage into at least one subfile, wherein each subfile is a stream subfile;
for each stream subfile:
identifying, by the computer, an item in the stream subfile;
analyzing, by the computer, the item in the stream subfile for an unwanted behavior by:
i) determining an acceptability of the unwanted behavior;
ii) distinguishing a visibility of the item; and
iii) recognizing a necessity of the item; and
processing, by the computer, based on a result of the analyzing step, the item in the stream subfile resulting in a processed subfile; and
assembling, by the computer, the processed subfiles into an output file having the same file format as the file format as the input file.

2. The method of claim 1, further comprising editing the output file with a word processing software for the file format of the input file.

3. The method of claim 1, wherein the file format is configured as a JTD (Ichitaro Word Processing) document file type having structure based on a Microsoft® Compound Document File (MCDF) format for the structured storage.

4. The method of claim 1, wherein the file format is configured as a HWP (Hangul Word Processor) document file type having structure based on a Microsoft® Compound Document File (MCDF) format for the structured storage.

5. The method of claim 1, wherein the output file is based on a Microsoft® Compound Document File (MCDF) format for the structured storage.

6. The method of claim 1, wherein the output file has less unwanted behavior or no unwanted behavior when compared to the input file.

7. The method of claim 1, wherein processing the item is performed by modifying the item in the stream subfile resulting in the processed subfile.

8. The method of claim 1, wherein processing the item is performed by removing the item from the stream subfile resulting in the processed subfile.

9. The method of claim 1, wherein processing the item is performed by keeping the item from the stream subfile resulting in the processed subfile.

10. A computerized system comprising:
a memory storing executable instructions; and
a processor, coupled to the memory, that performs a Content Disarm and Reconstruction (CDR) method by executing the instructions stored in the memory, the method comprising:
receiving, by the processor, an input file having a file format configured with a structured storage;
disassembling, by the processor, the structured storage into at least one subfile, wherein each subfile is a stream subfile;
for each stream subfile:
identifying, by the processor, an item in the stream subfile;
analyzing, by the processor, the item in the stream subfile for an unwanted behavior by:
i) determining an acceptability of the unwanted behavior;
ii) distinguishing a visibility of the item; and
iii) recognizing a necessity of the item; and
processing, by the processor, based on a result of the analyzing step, the item in the stream subfile resulting in a processed subfile; and
assembling, by the processor, the processed subfiles into an output file having the same file format as the file format as the input file.

11. The system of claim 10, wherein the method further comprises editing the output file with a word processing software for the file format of the input file.

12. The system of claim 10, wherein the file format is configured as a JTD (Ichitaro Word Processing) document file type having structure based on a Microsoft Compound Document File (MCDF) format for the structured storage.

13. The system of claim 10, wherein the file format is configured as a HWP (Hangul Word Processor) document file type having structure based on a Microsoft Compound Document File (MCDF) format for the structured storage.

14. The system of claim 10, wherein the output file is based on a Microsoft Compound Document File (MCDF) format for the structured storage.

15. The system of claim 10, wherein the output file has less unwanted behavior or no unwanted behavior when compared to the input file.

16. A non-transitory computer readable medium comprising instructions that, when executed by a processor, cause the processor to perform operations comprising:
receiving, by the processor, an input file having a file format configured with a structured storage;
disassembling, by the processor, the structured storage into at least one subfile, wherein each subfile is a stream subfile;
for each stream subfile:
identifying, by the processor, an item in the stream subfile;
analyzing, by the processor, the item in the stream subfile for an unwanted behavior by:
i) determining an acceptability of the unwanted behavior;
ii) distinguishing a visibility of the item; and
iii) recognizing a necessity of the item; and
processing, by the processor, based on a result of the analyzing step, the item in the stream subfile resulting in a processed subfile; and
assembling, by the processor, the processed subfiles into an output file having the same file format as the file format as the input file.

17. The non-transitory computer readable medium of claim 16, further comprising editing the output file with a word processing software for the file format of the input file.

18. The non-transitory computer readable medium of claim 16, wherein the file format is configured as a JTD (Ichitaro Word Processing) document file type having structure based on a Microsoft Compound Document File (MCDF) format for the structured storage.

19. The non-transitory computer readable medium of claim 16, wherein the file format is configured as a HWP (Hangul Word Processor) document file type having structure based on a Microsoft Compound Document File (MCDF) format for the structured storage.

20. The non-transitory computer readable medium of claim 16, wherein the output file is based on a Microsoft Compound Document File (MCDF) format for the structured storage.
